(19) United States
(12) Patent Application Publication
(10) Pub. No.: US 2019/0322038 A1
(43) Pub. Date: Oct. 24, 2019

(54) APPARATUS AND METHOD FOR FABRICATION WITH CURABLE RESINS BY EXTRUSION AND PHOTO CURING

(71) Applicant: General Electric Company, Schenectady, NY (US)

(72) Inventor: Mary Kathryn Thompson, Hamilton, OH (US)

(21) Appl. No.: 16/213,508

(22) Filed: Dec. 7, 2018

Related U.S. Application Data
(60) Provisional application No. 62/661,257, filed on Apr. 23, 2018.

(51) Int. Cl. B29C 64/165; B29C 64/135; B29C 64/277; B29C 64/188; B29C 64/232; B29C 64/236; B29C 70/58; B29C 70/06; B29C 70/02

(52) U.S. Cl. CPC B29C 64/165; B29C 64/135; B29C 64/277; B29C 64/188; B33Y 10/00; B29C 64/236; B29C 70/58; B29C 70/06; B29C 70/021; B29C 64/232

(57) ABSTRACT

An additive manufacturing apparatus includes: a build surface for receiving and supporting the part; a material depositor operable to selectively deposit a bead of radiant-energy-curable resin on the build surface; one or more actuators operable to change the relative positions of the build surface and the material depositor, such that the bead is deposited along a build path; and a radiant energy apparatus operable to generate and project radiant energy on the deposited material. A method is provided for producing a component using the apparatus.

### BACKGROUND OF THE INVENTION

This invention relates generally to additive manufacturing, and more particularly to methods for curable material handling in additive manufacturing.

Additive manufacturing is a process in which material is built up piece-by-piece, line-by-line, or layer-by-layer to form a component. Numerous methods are known in the art.

Heavily loaded photocurable mixtures and slurries (e.g. metal and ceramic loaded photopolymers) offer the potential for ultra-high accuracy metal and ceramic additive manufacturing by following the steps of deposition and curing with post-sinter. However, in the prior art, this has often required expensive optical systems and/or complex material handling systems. Creating multi-material objects with existing systems is onerous. There may also be size limitations to the parts that can be created. There may also be limitations on the use of continuous fiber for reinforcement and on specifying the orientation of reinforcement fibers.

Similarly, filled photocurable mixtures (e.g. carbon or glass fiber reinforced photopolymers) offer the potential for additive manufacture of ultra-high accuracy parts with properties (e.g. mechanical, thermal, or magnetic) that are superior to their unfilled counterparts.

Simpler deposition systems are known, such as fused deposition modeling (“FDM”), but these have been limited to un-filled and un-loaded resins or produce less accurate parts.

### BRIEF DESCRIPTION OF THE INVENTION

At least one of these problems is addressed by an additive manufacturing method which adapts existing lower-cost “high accuracy” FDM concepts to selectively extrude and deposit the filled or loaded photocurable mixture, cure in situ, and with an optional post-sinter to create a filled or loaded photopolymer FDM-like process.

According to one aspect of the technology described herein, an additive manufacturing apparatus includes: a build surface; a material depositor operable to selectively deposit a bead of radiant-energy-curable resin on the build surface; one or more actuators operable to change the relative positions of the build surface and the material depositor, such that the bead is deposited along a build path; and a radiant energy apparatus operable to generate and project radiant energy on the deposited resin.

According to another aspect of the technology described herein, a method for producing a component includes: using at least one material depositor to selectively deposit a bead of radiant-energy-curable resin on a build surface or onto resin that has already been deposited on the build surface, wherein, during deposition, one or more actuators are used to change the relative positions of the build surface and the material depositor, such that the bead is deposited along a build path; locally curing the bead of resin using an application of radiant energy from at least one radiant energy apparatus; and repeating the steps of depositing and curing until the component is complete.

### BRIEF DESCRIPTION OF THE DRAWINGS

The invention may be best understood by reference to the following description taken in conjunction with the accompanying drawing figures in which:

FIG. 1 is a schematic perspective view of an exemplary additive manufacturing apparatus, showing an exemplary in-line radiant energy apparatus;

FIG. 2 is a schematic perspective view of an additive manufacturing apparatus showing an alternative radiant energy apparatus;

FIG. 3 is a schematic perspective view of an additive manufacturing apparatus showing another alternative radiant energy apparatus;

FIG. 4 is a schematic side elevation view of the apparatus of FIG. 1 in operation;

FIG. 5 is a top plan view of a portion of FIG. 4;

FIG. 6 is a schematic top plan view illustrating an aspect of a deposition and curing process;

FIG. 7 is a schematic top plan view illustrating another aspect of the deposition and curing process;

FIG. 8 is a schematic cross-sectional view of an embodiment of a material depositor;

FIG. 9 is a schematic perspective view of a radiant energy apparatus surrounded by a shield;

FIG. 10 is a schematic top plan view of a variable size nozzle orifice; and

FIG. 11 is a schematic top plan view illustrating an alternative aspect of the deposition and curing process.

### DETAILED DESCRIPTION OF THE INVENTION

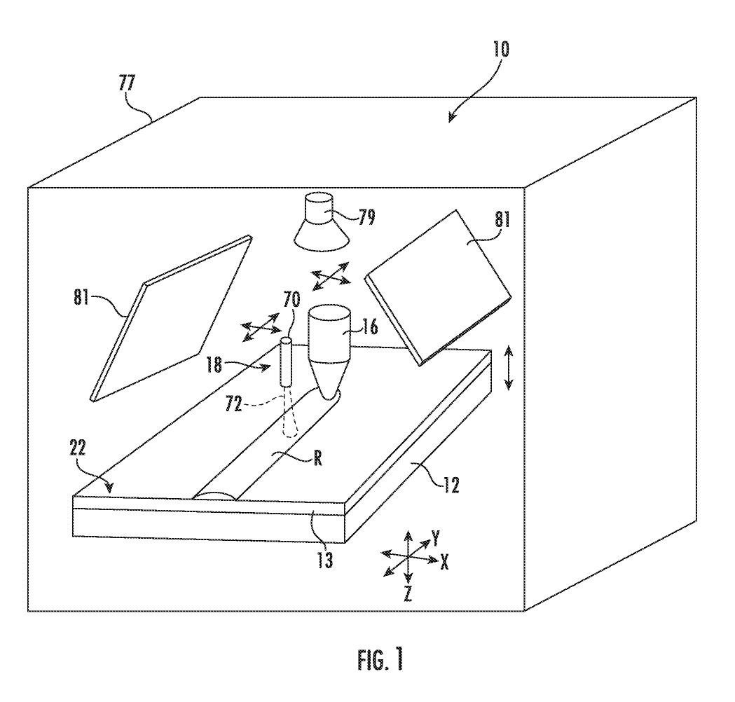

Referring to the drawings wherein identical reference numerals denote the same elements throughout the various views, FIG. 1 illustrates schematically an example of one type of suitable apparatus 10 for carrying out an additive manufacturing method. It will be understood that other configurations of equipment may be used to carry out the method described herein. Basic components of the exemplary apparatus 10 include a build table 12, a material depositor 16, and a radiant energy apparatus 18. Each of these components will be described in more detail below.

The build table 12 is a structure defining a planar build surface 22. In this particular example, it is shown as being planar. However, other shapes could be used. For example, the build surface 22 could be curved in one or two dimensions or have a periodic or textured (grooved or wavy) form. It could take the form of a mandrel or form rather than a literal “table”. For purposes of convenient description, the build surface 22 may be considered to be oriented parallel to an X-Y plane of the apparatus 10, and a direction perpendicular to the X-Y plane is denoted as a Z-direction (X, Y, and Z being three mutually perpendicular directions). If the build surface 22 is not planar, then another appropriate coordinate system may be used for reference, such as a 2-D or 3-D cylindrical or polar coordinate system. Optionally, the build surface 22 may be defined by a separate top member 13 which is removably secured to the build table 12. This permits the top member 13 to be detached and removed from the apparatus 10 with the completed component attached. A clean top member 13 can be secured to the build table 12, and processing of a new component can take place while the completed component is separated from the build surface 22, without impeding use of the apparatus 10. In the illustrated example the top member 13 is a flat plate, but curved shapes, non-uniform shapes, or periodic or textured (e.g. grooved or wavy) shapes could be used as well.

The material depositor 16 may be any device or combination of devices which is operable to apply a layer of resin R over the build table 12. In the example shown in FIG. 1, the material depositor 16 includes a hollow tube 36 including a nozzle orifice 38 (see FIG. 4). In use, resin R optionally including a filler would be pumped into the interior of the tube 36 and discharged onto the build surface 22 through the nozzle orifice 38. The depositor 16 may include a reservoir 17 which holds a supply of resin R and feeds the tube 36, as seen in FIG. 8. The reservoir optionally incorporates some means for agitating or mixing the resin R contained within. For example, the reservoir 17 may be movable (e.g. rotatable, translatable, etc.) to produce a mixing action. Alternatively, the reservoir 17 may include one or more movable mixing elements such as the illustrated paddle or agitator 19.

Some means (not shown) are provided for causing controlled movement of the material depositor 16 and the build table 12 relative to each other (e.g., in the X-, Y-, and Z-directions or in multiple directions in another coordinate system). Devices such as pneumatic cylinders, hydraulic cylinders, ballscrew electric actuators, linear electric actuators, or delta drives may be used for this purpose.

The necessary movements may be derived from movements of one or both of the build table 12 and the material depositor 16. For example, the build table 12 could be stationary and the material depositor 16 could be movable in several directions. As another example, the material depositor could be stationary and the build table 12 could be movable in several directions. As yet another example, the material depositor 16 could be movable in X- and Y-directions and the build table 12 could be movable in the Z-direction.

The radiant energy apparatus 18 may comprise any device or combination of devices operable to generate and project radiant energy on the resin R in a suitable pattern and with a suitable energy level and other operating characteristics to cure the resin R during the build process, described in more detail below.

In general, the radiant energy apparatus 18 may be configured to be both selective and localized. As used herein, “selective” curing refers to applying radiant energy in a pattern representative of some portion of the component being made. Generally, selective application involves directing energy in an area smaller than the exposed surface area of the uncured resin R. Examples of selective application modalities would include a beam focal spot or image pixel. As used herein, “localized” or “local” curing refers to applying radiant energy in an area smaller than the total build surface 22 and in the general vicinity of the material depositor 16.

In one exemplary embodiment, the radiant energy apparatus 18 may comprise a “point source beam apparatus” used herein to refer generally to refer to any device operable to generate a radiant energy beam of suitable energy level and other operating characteristics to cure the resin R. FIG. 1 shows an example of beam apparatus 70 comprising a radiant energy source. The radiant energy source may comprise any device operable to generate a beam 72 of suitable power and other operating characteristics to cure the resin R. Nonlimiting examples of suitable radiant energy sources include lasers, LEDs, or electron beam guns. This particular example is also “inline”, meaning it is movable and configured to generally track or follow the movement of the material depositor 16. Movement of the radiant energy source in at least one direction to follow the path of the material depositor 16 may be effected, for example, by physically connecting or linking the radiant energy source to the material depositor 16, (exemplary bracket 71 shown in FIG. 4), or by providing independent actuating mechanisms for the radiant energy source (not shown). In this type of apparatus, the inline projected beam 72 would tend to be oriented parallel to the material depositor 16 and normal to the newly laid bead of resin R at all times.

Optionally, as shown in FIG. 9, the radiant energy apparatus 18 may be wholly or partially surrounded by a shield 21 of a radio-opaque material. The shield 21 may be shaped and sized as needed to avoid exposing uncured resin R located on the build surface 22 away from the area actively being cured, thus facilitating a curing process that is local to the deposited uncured resin R, but which can be nonselective. For example, a defocused beam, large-area DLP footprint, or UV lamp could be used in conjunction with the shield 21 to provide curing energy which is gross, or nonselective but localized.

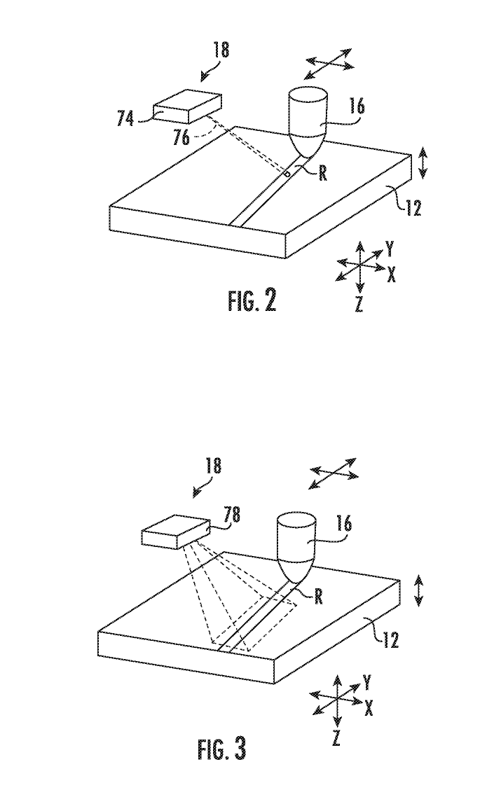

Alternatively, the radiant energy apparatus 18 may comprise a “scanned beam apparatus” used herein to refer generally to refer to any device operable to generate a radiant energy beam of suitable energy level and other operating characteristics to cure the resin R and to scan the beam over the surface of the resin R in a desired pattern. FIG. 2 shows an example of a scanned beam apparatus 74 including therein a radiant energy source and a beam steering apparatus (not individually illustrated). In this type of apparatus, the angle of incidence of the curing beam on the resin R will vary as the beam is scanned. The scanned beam apparatus 74 may be mounted in a fixed location as shown or alternatively, it may be “inline”, i.e., movement of the scanned beam apparatus 74 in at least one direction to follow the path of the material depositor 16 may be effected. This could be done, for example, by physically connecting or linking the radiant energy source to the material depositor 16, or by providing independent actuating mechanisms for the radiant energy source (not shown). The scanned beam apparatus is capable of selective curing. As used herein, the term “selective curing” or “selectively curing” refers to a process in which curing radiation is applied in a controlled manner such that it defines the geometry of one or more features or boundaries of the component. Stated another way, in a selective curing process, the component accuracy is determined by the accuracy of the radiant energy apparatus.

The beam steering apparatus may include one or more mirrors, prisms, and/or lenses and may be provided with suitable actuators, and arranged so that a beam 76 from the radiant energy source can be focused to a desired spot size and steered to a desired position in plane coincident with the surface of the resin R. The beam steering apparatus may be operable to scan the beam 76 in two, three, or more degrees of freedom. The beam may be referred to herein as a “build beam”. Other types of scanned beam apparatus may be used. For example, scanned beam sources using multiple build beams are known.

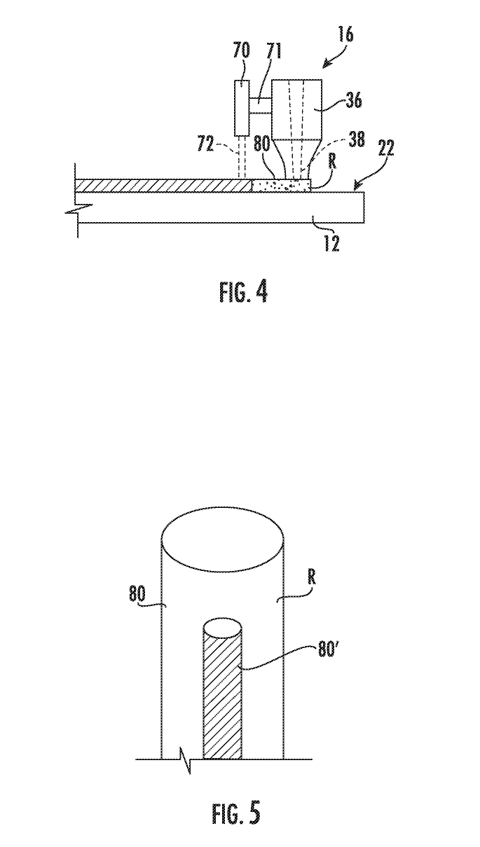

In another exemplary embodiment as shown in FIG. 3, the radiant energy apparatus 18 may comprise an area-curing apparatus 78, used herein generally to refer to a device operable to project radiant energy over all or a portion of the build table 12, or stated another way, in a footprint wider than then deposited bead of resin. In one example, the area-curing apparatus 78 may comprise a (nonselective) radiant energy source such as a UV flash lamp. The area-curing apparatus may be stationary or may be movable to illuminate one defined section (“tile”) of the build area at a time. Optionally, the area-curing apparatus 78 may be “inline”, i.e. movement of the radiant energy source in at least one direction to follow the path of the material depositor 16 may be effected. This may be done, for example, by physically connecting or linking the radiant energy source to the material depositor 16, or by providing independent actuating mechanisms for the radiant energy source (not shown).

In another example, the area-curing apparatus 78 may comprise a “projector”, used herein generally to refer to any device operable to generate a radiant energy patterned image of suitable energy level and other operating characteristics to cure the resin R. As used herein, the term “patterned image” refers to a projection of radiant energy comprising an array of individual pixels. This is a selective curing device. Nonlimiting examples of patterned imaged devices include a DLP projector or another digital micromirror device, a 1D or 2D array of LEDs, a 1D or 2D array of lasers, or a 1D or 2D array of optically addressed light valves. Optionally, a projector may incorporate additional means such as actuators, mirrors, etc. configured to selectively move an image forming apparatus or other parts of the projector, with the effect of rastering or shifting the location of the patterned image on the build surface 22. This permits a single projector to cover a larger build area, for example. Means for rastering or shifting the patterned image are commercially available. This type of image projection may be referred to herein as a “tiled image”.

The apparatus 10 may further include an additional nonselective curing radiation source operable to flood the build surface 22 with radiant energy. This could be used, for example, for a post-build curing operation. In an example shown in FIG. 1, a curing radiation source 79 is shown schematically. A UV lamp or similar device could be used. Optionally, one or more reflectors 81 may be provided, positioned to reflect the radiant energy from the additional curing source towards the build surface 22.

The apparatus 10 may include a controller (not shown), comprising hardware and software required to control the operation of the apparatus 10, including some or all of the material depositor 16, the build table 12, the radiant energy apparatus 18, and the various actuators described above. The controller may be embodied, for example, by software running on one or more processors embodied in one or more devices such as a programmable logic controller (“PLC”) or a microcomputer. Such processors may be coupled to sensors and operating components, for example, through wired or wireless connections. The same processor or processors may be used to retrieve and analyze sensor data, for statistical analysis, and for feedback control.

Optionally, the components of the apparatus 10 may be surrounded by a housing (shown schematically at 77 in FIG. 1), which may be used to provide a shielding or inert gas atmosphere. Optionally, the housing could be temperature and/or humidity controlled. Optionally, ventilation of the housing could be controlled based on factors such as a time interval, temperature, humidity, and/or chemical species concentration. Optionally, the housing may block specific wavelengths of energy to protect the user from the radiant energy source.

The resin R comprises a material which is radiant-energy curable and which is capable of adhering or binding together the filler (if used) in the cured state. As used herein, the term “radiant-energy curable” refers to any material which solidifies in response to the application of radiant energy of a particular frequency and energy level. For example, the resin R may comprise a known type of photopolymer resin containing photo-initiator compounds functioning to trigger a polymerization reaction, causing the resin to change from a liquid state to a solid state. Alternatively, the resin R may comprise a material which contains a solvent that may be evaporated out by the application of radiant energy.

Generally, the resin R should be flowable so that it can be deposited on the build surface 22. A suitable resin R will be a material that is relatively thick, i.e. its viscosity should be sufficient that it will remain in position where it is dispensed by the material depositor 16, and not run off of the build table 12 during the curing process. The composition of the resin R may be selected as desired to suit a particular application. Mixtures of different compositions may be used.

The resin R may be selected to have the ability to out-gas or burn off during further processing, such as a sintering process.

The resin R may incorporate a filler. The filler may be pre-mixed with resin R, then loaded into the material depositor 16. The filler comprises particles, which are conventionally defined as “a very small bit of matter”. The filler may comprise any material which is chemically and physically compatible with the selected resin R. The particles may be regular or irregular in shape, may be uniform or non-uniform in size, and may have variable aspect ratios. For example, the particles may take the form of powder, of small spheres or granules, or may be shaped like small rods or fibers. The filler may also include longer fibers or continuous fibers. The fibers may be oriented in the resin prior to extrusion.

The composition of the filler, including its chemistry and microstructure, may be selected as desired to suit a particular application. For example, the filler may be metallic, ceramic, polymeric, and/or organic. Mixtures of different compositions may be used.

The filler may be “fusible”, meaning it is capable of consolidation into a mass upon via application of sufficient energy. For example, fusibility is a characteristic of many available polymeric, ceramic, and metallic powders.

The proportion of filler to resin R may be selected to suit a particular application. Generally, any amount of filler may be used so long as the combined material is capable of flowing, and there is sufficient resin R to hold together the particles of the filler in the cured state. The mixture of resin R and filler may be referred to as a “slurry” or a “paste”.

Examples of the operation of the apparatus 10 will now be described in detail. It will be understood that, as a precursor to producing a component and using the apparatus 10, the component to be produced is software modeled for the purpose of developing a set of command instructions for operation of the apparatus 10. For example, the component could be modeled as a stack of planar layers arrayed along the Z-axis.

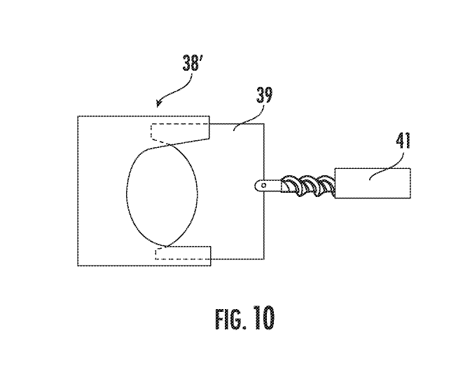

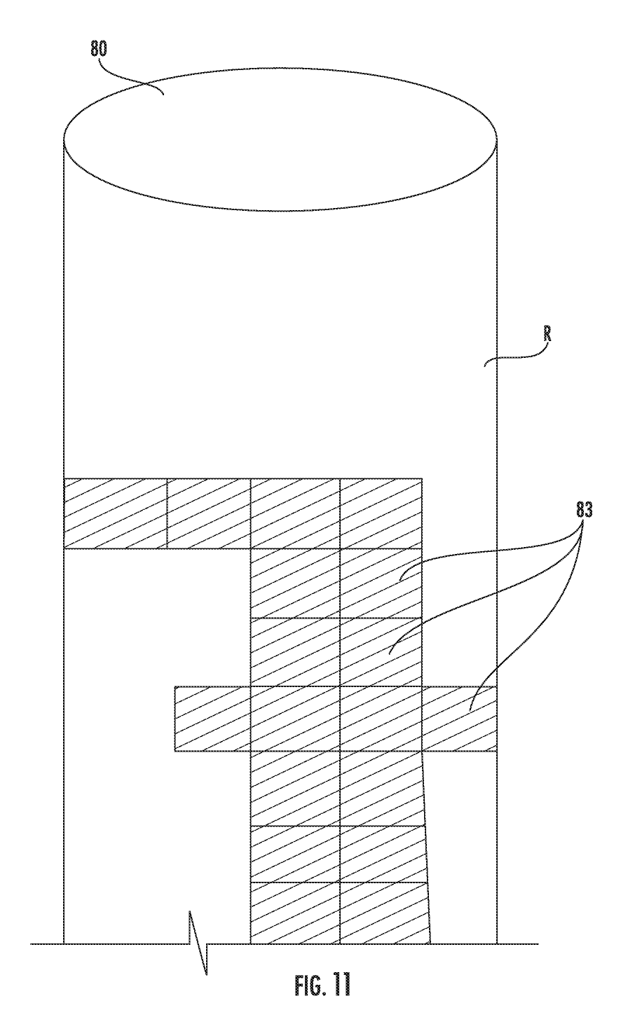

Referring to FIGS. 4 and 5, the material depositor 16 is used to apply resin R to the build surface 22. In the illustrated example, resin R flows out the nozzle orifice 38 and onto the build table 12, forming an elongated bead 80 in response to relative motion of the depositor 16 and the build surface 22. The Z-axis height (i.e. layer thickness) is determined by the distance between the material depositor 16 and the build surface 22. The width of the bead 80 may be variable (e.g., by using a different nozzle, mechanically adjusting the size of a variable diameter nozzle orifice 38, etc.). FIG. 10 shows an example of a variable diameter orifice 38′ implemented by using a moveable shutter 39 and actuator 41. The layer increment can be variable, with thicker layers in some areas and thinner layers in others. The layer thickness may be adjusted based on the penetration of the curing energy or the desired build speed. The curing energy may also be adjusted based on the layer thickness. The bead 80 does not have to be supported by the build surface 22 or by an existing uncured or partially cured resin at every location. Resin may be deposited and cured to create cantilevered or self-supporting structures.

Optionally, the depositor 16 may be heated either to control viscosity and therefore material flow rate as it is laid down or to partially melt and therefore mechanically smooth out existing beads 80.

Optionally, different portions of the bead 80 (and thus different sections of the final component) may comprise two or more different material combinations of resin R and/or filler. As used herein, the term “combination” refers to any difference in either of the constituents. So, for example, a particular resin composition mixed with two different filler compositions would represent two different material combinations.

Optionally, different portions of the bead 80 may comprise two or more different materials, wherein at least one of the materials is intended to comprise some of the final part and wherein another of the materials is a support material which will be removed after printing or after the final post-sinter. The support material may be photocurable. The support material may be curable or non-curable (e.g. a more classical thermoplastic FDM material). The support material may be dissolvable. The support material may resist adhesion to the build material during the printing process or during the sintering process. The support material may be deposited using a different mechanism (e.g. nozzle) than the build material. Support strategies and support materials are known in the art.

Once the resin R with filler has been applied and the layer increment defined, the radiant energy apparatus 18 is used to cure the resin R in a desired pattern. It will be understood that the resin R is typically only partially cured by the radiant energy apparatus, such that one bead, layer, or portion can be fused with a subsequent bead, layer, or portion, with the curing being further progressed and/or completed during curing of the subsequent bead, layer, or portion.

In one embodiment, the basic accuracy level would be defined by the accuracy of the deposition apparatus. For example, where an area-curing apparatus 78 is used, the curing step may be a “gross” cure in which either the entire build surface 22 is exposed to radiant energy, or radiant energy is applied in a pattern roughly approximating the location of uncured resin R on the build surface 22. In this type of apparatus and method, the effective focal spot size of the curing apparatus, or the width of the projected area of curing radiation, would generally be greater than the size of the bead of the resin R.

In another embodiment, the accuracy level would be defined by the accuracy of the radiant energy apparatus 18. In this embodiment, the radiant energy apparatus may project a beam with a pixel size or focal spot size (or the width of the projected area of curing radiation) smaller than the deposited bead of resin R. For example, where a scanned beam apparatus is used, the build beam 76 is steered over the exposed resin R in an appropriate pattern. Alternatively, where an in-line beam apparatus 70 is used, the radiant energy source emits a build beam 72 and the radiant energy source is physically moved over the exposed resin R in an appropriate pattern. Alternatively, where a projector is used, the radiant energy source emits a patterned image (which may optionally be tiled) over the exposed resin R. This embodiment represents selective, localized curing as defined above. It will be understood that some portions of the resin R may be selectively cured, while other portions of the resin R are cured locally in a nonselective manner. This can increase processing speed by using a faster, less accurate curing process in areas where best accuracy is not required. For example, this may be true of portions of a component distant from edges or boundaries.

The deposition and curing process is continued until the desired component is built up. The material may be laid down and cured in an appropriate pattern depending on multiple factors including the component size, desired accuracy, desired speed, material composition, and so forth.

When a beam-type cure source is used, the build method is a line-by-line process. Each line consists of a larger uncured bead and a smaller cured trail (indicated by reference 80′ in FIG. 5). The uncured bead is malleable or flowable. It can be pushed out of the way by the depositor 16 or by some mechanism associated with the movement of the depositor 16 (a blade out in front, a blade attached, etc.). The cured trail is more rigid. It should stay in place so long as the depositor 16 does not directly contact it. FIG. 11 shows the differing result where a projector is used to cure a bead 80 with a selective trail of pixels 83.

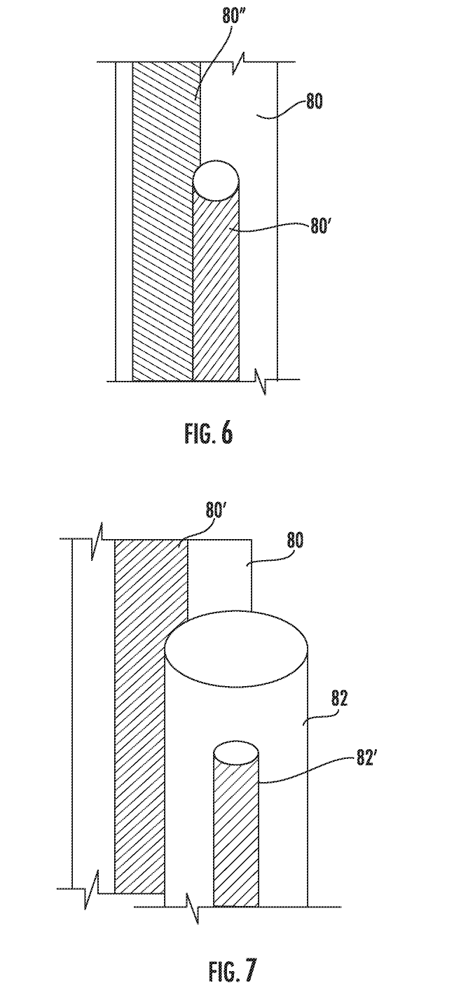

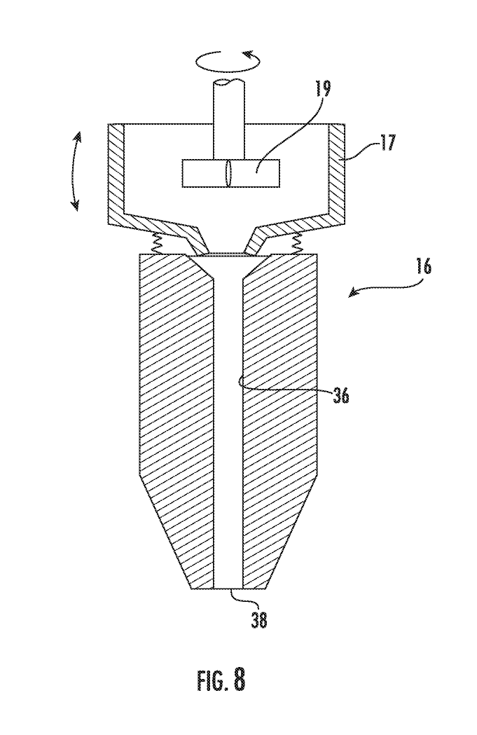

If the bead width is relatively large and the beam width relatively small, it is possible to raster the build beam over the bead 80 more than once. For example, FIG. 6 shows an example where a bead 80 is cured in multiple passes, with items 80′ and 80″ referring to laterally overlapping cured trails.

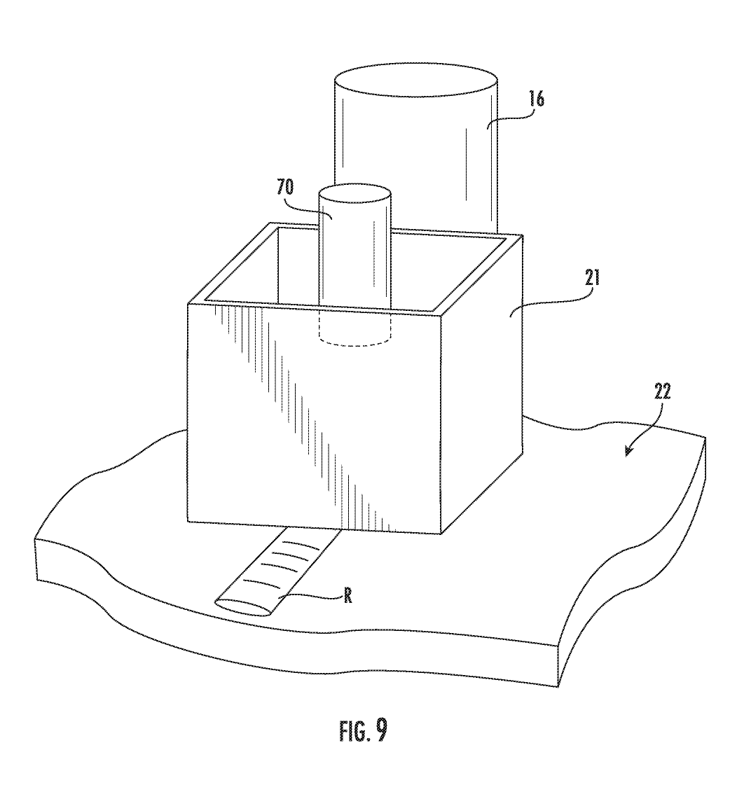

To build up a part, an existing trail 80′ of “cured” (that is, partially cured as noted above) resin R must be placed in contact with uncured resin R and that uncured resin R must then be at least partially cured such that the old trail and the new trail can share linked polymers. The fusing between adjacent lines or trails can be vertical (e.g., stacks of lines) or it can be horizontal (e.g., one line fusing to the line next to it) or any other geometric configuration that is dimensionally stable. FIG. 7 shows an example of two adjacent beads 80, 82 which are deposited and cured sequentially (see “cured” trails 80′, 82′ respectively). The new and old trails have a predetermined lateral spacing—they can overlap, just barely touch, or can possibly be slightly apart (diffuse scattering of radiant energy means that there can be partial curing in material that is not directly in line of sight to the radiant energy apparatus 18).

Any of the curing methods described above results in a component in which the filler (if used) is held in a solid shape by the cured resin R. This component may be usable as an end product for some conditions. Subsequent to the curing step, the component may be removed from the build table 12.

If the end product is intended to be purely ceramic or metallic, the component may be treated to a conventional sintering process to burn out the resin R and to consolidate the ceramic or metallic particles. Optionally, a known infiltration process may be carried out during or after the sintering process, in order to fill voids in the component with a material having a lower melting temperature than the filler. The infiltration process improves component physical properties. Optionally, the component may be treated to a conventional hot isostatic pressing (HIP) process to reduce its porosity and increase its density.

The method and apparatus described herein has several advantages over the prior art. In particular, it is believed to be more cost effective than loaded DLP. It has a larger maximum build size than loaded DLP. Multi-material deposition is possible and easier than traditional photocuring because it requires little or no cleaning to start depositing the new material. Continuous fiber reinforcement is possible. It may be safer than binder jet processes because the particles are entrapped in the resin prior to sintering.

The foregoing has described a method and apparatus for additive manufacturing. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. An additive manufacturing apparatus, comprising:
a build surface;
a material depositor operable to selectively deposit a bead of radiant-energy- curable resin on the build surface;
one or more actuators operable to change the relative positions of the build surface and the material depositor, such that the bead is deposited along a build path; and
a radiant energy apparatus operable to generate and selectively project radiant energy on the deposited resin.

2. The apparatus of claim 1, wherein the resin includes a particulate material filler.

3. The apparatus of claim 1, wherein the radiant energy apparatus is a point source configured to project a beam of radiant energy.

4. The apparatus of claim 1, wherein the radiant energy apparatus is a scanned beam apparatus.

5. The apparatus of claim 1, wherein the radiant energy apparatus is a projector operable to project a patterned image

6. The apparatus of claim 1, wherein the radiant energy apparatus is an inline cure source that is configured to travel along with the material depositor.

7. The apparatus of claim 6, wherein the inline cure source is physically linked to the material depositor, thereby causing it to traverse the build path, at the same speed as the material depositor.

8. The apparatus of claim 1, further comprising at least one additional material depositor which is capable of independent movement.

9. The apparatus of claim 1, further comprising at least one additional radiant energy apparatus which is capable of independent movement.

10. The apparatus of claim 1, wherein multiple radiant energy sources are positioned to at least partially surround the deposited bead.

11. The apparatus of claim 10, wherein the radiant energy sources can be moved independently.

12. The apparatus of claim 1, wherein the radiant energy apparatus is surrounded at least in part within a shield which is radio-opaque.

13. The apparatus of claim 1, further including at least one additional curing radiation source operable to flood the build surface with radiant energy.

14. The apparatus of claim 13, further including at least one reflector positioned to reflect the radiant energy from the additional curing source towards the build surface.

15. The apparatus of claim 1, wherein the build surface is defined by a top member which is removably secured to a build table.

16. The apparatus of claim 1, wherein the material depositor includes a nozzle having a variable orifice size.

17. A method for producing a component, comprising:
using at least one material depositor to selectively deposit a bead of radiant- energy-curable resin on a build surface or connected to resin that has already been deposited on the build surface, wherein, during deposition, one or more actuators are used to change the relative positions of the build surface and the material depositor, such that the bead is deposited along a build path;
selectively curing at least a part of the bead of resin using an application of radiant energy from at least one radiant energy apparatus; and
repeating the steps of depositing and curing until the component is complete.

18. The method of claim 17, wherein at least a portion of the bead is locally, nonselectively cured.

19. The method of claim 18, wherein different portions of the bead are cured using two or more different radiant energy apparatuses, at least one of which is selective and at least one of which is nonselective.

20. The method of claim 19 wherein at least one of the radiant energy apparatuses is a scanned beam apparatus.

21. The method of claim 17, wherein two or more adjacent beads are deposited and cured as a series of laterally-overlapping trails.

22. The method of claim 17, wherein two or more adjacent beads are deposited with a predetermined lateral spacing

23. The method of claim 20, wherein the resin includes a particulate material filler.

24. The method of claim 23, further comprising sintering the component to burn out the cured resin and consolidate the filler.

25. The method of claim 24, further comprising infiltrating a lower-melting-temperature material into the component during or after sintering.

26. The method of claim 24, further comprising a hot isostatic pressing step.

27. The method of claim 21, wherein the resin is supplied such that the resin in at least one section of the component has a different composition than the resin in another section of the component.

28. The method of claim 21, wherein the resin contains a mixture of more than one material.

29. The method of claim 21 wherein the finished component is post-cured by flooding the component with radiant energy.
